(19) United States
(12) Patent Application Publication
(10) Pub. No.: US 2025/0236146 A1
(43) Pub. Date: Jul. 24, 2025

(54) VEHICLE JOINT AND BUSHING ASSEMBLY

(71) Applicant: FCA US LLC, Auburn Hills, MI (US)

(72) Inventors: James A. Robertson, White Lake, MI (US); William S Pfarrer, JR., Oakland Township, MI (US); Steven M. Vargo, Waterford, MI (US)

(21) Appl. No.: 18/417,349

(22) Filed: Jan. 19, 2024

(51) Int. Cl. B60G 7/00

(52) U.S. Cl. CPC B60G 7/008; B60G 2204/143; B60G 2204/41042

(57) ABSTRACT

A vehicle joint and bushing assembly furnishes movements of a supported component for desired adjustments and alignments to be made thereat. The vehicle joint and bushing assembly can be installed for use with joints in automotive vehicles such as for adjustments and alignment to suspension control arms and steering knuckles, among other applications and components. In various implementations, the vehicle joint and bushing assembly involves a joint opening and has one or more sleeves. A retention member is supported by the sleeve(s). The retention member is able to move to off-center positions via the sleeve(s) and relative to a centerline of the joint opening in order to adjust and align the supported component.

### FIELD

The present disclosure relates to vehicle joints and bushings and, more particularly, to adjustable vehicle joints and bushings for alignment and potentially other purposes.

### BACKGROUND

Bushings are used in vehicle applications to minimize energy transmissions, such as vibrations, between two parts or components connected together thereby. A certain amount of relative movement between the parts or components is often facilitated via the associated bushing. In automotive applications, as an example, bushings are commonly equipped at connections between suspension components for controlled movements that can occur when encountering bumps or other road conditions amid travel. Control arms, for instance, are typically mounted with bushings. Adjustments at the bushings for vehicle alignment purposes of the parts or components can sometimes be called for. This is not uncommon, for example, when wheel alignment is carried out for an automobile at an automotive assembly plant or at an automotive dealership or other service facility.

### SUMMARY

In at least some implementations, a vehicle joint and bushing assembly may include a joint opening, a first sleeve, and a second sleeve. The joint opening has a first centerline. The first sleeve is receivable in the joint opening. The first sleeve has a second centerline. The second sleeve is locatable within the first sleeve. Upon rotation at the vehicle joint and bushing assembly between a first rotational position and a second rotational position, a retention centerline of a retention member is moveable with respect to the first centerline of the joint opening and is moveable with respect to the second centerline of the first sleeve. The retention member is locatable within the second sleeve.

In at least some implementations, a vehicle joint and bushing assembly may include a joint opening, one or more sleeves, and a retention member. The joint opening has a centerline. The sleeve(s) is locatable in the joint opening. The retention member is supported by way of the sleeve(s). The retention member is moveable to off-center positions with respect to the centerline of the joint opening upon rotation at the vehicle joint and bushing assembly.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a segmented view of an automotive suspension application in which a vehicle joint and bushing assembly can be equipped;

FIG. 2 is a perspective view of an embodiment of a vehicle joint and bushing assembly;

FIG. 3 is a side view of the vehicle joint and bushing assembly of FIG. 2;

FIG. 4 is an opposite side view of the vehicle joint and bushing assembly of FIG. 2, showing an embodiment of an offset arrangement;

FIG. 5 shows an embodiment of an indexing construction of the vehicle joint and bushing assembly of FIG. 2;

FIG. 6 shows an embodiment of another indexing construction of the vehicle joint and bushing assembly of FIG. 2;

FIG. 7 is a sectional view of the vehicle joint and bushing assembly of FIG. 2;

FIG. 8 is an exploded view of the vehicle joint and bushing assembly of FIG. 2;

FIG. 9 is a perspective view of another embodiment of a vehicle joint and bushing assembly;

FIG. 10 is a side view of the vehicle joint and bushing assembly of FIG. 9;

FIG. 11 is the side view of the vehicle joint and bushing assembly of FIG. 9 but with a component removed to show an embodiment of reacting structures;

FIG. 12 shows an embodiment of a slotted passage of the vehicle joint and bushing assembly of FIG. 9;

FIG. 13 is a perspective view of an opposite side of the vehicle joint and bushing assembly of FIG. 9;

FIG. 14 is another perspective view of the opposite side of the vehicle joint and bushing assembly of FIG. 9;

FIG. 15 is an opposite side view of the vehicle joint and bushing assembly of FIG. 9, but with components removed for viewability purposes;

FIG. 16 shows the opposite side of the vehicle joint and bushing assembly of FIG. 9, but with components removed for viewability purposes; and

FIG. 17 is an exploded view of the vehicle joint and bushing assembly of FIG. 9.

### DETAILED DESCRIPTION

Referring in more detail to the drawings, embodiments of a vehicle joint and bushing assembly 10 are presented that furnish improved adjustability thereat and alignment of accompanying components at and downstream of the established connection. The figures depict the vehicle joint and bushing assembly 10 in an automotive application and with suspension components, but employment of the vehicle joint and bushing assembly 10 is more wide-ranging and could involve automotive steering components, aerospace wheel components, as well as other applications and components where certain adjustments and alignments are made including other types of vehicles. Compared to previous approaches, adjustment constructions in the embodiments of the vehicle joint and bushing assembly 10 are minimized in terms of their overall packaging—and indeed can be carried out largely internally of the vehicle joint and bushing assembly 10, as set forth below—in order to accommodate and satisfy certain packaging demands that can be tight and inflexible at an exterior of the vehicle joint and bushing assembly 10 per some applications. In some embodiments herein, the designs and constructions that effect adjustability of the vehicle joint and bushing assembly 10 are more efficiently and effectively integrated into the overall design and construction of the assembly itself, more readily facilitating adjustments at the vehicle joint and bushing assembly 10 when desired. Moreover, the embodiments of the vehicle joint and bushing assembly 10 furnish adjustment movements, and hence component alignments, in any directions and/or angles relative to a retention member supported thereat. This contrasts with previous approaches that often only permitted movements in a single direction (e.g., perpendicular direction with respect to a bolt axis), or that required costly shim plates for movements in other directions and that introduce other unwanted complexities.

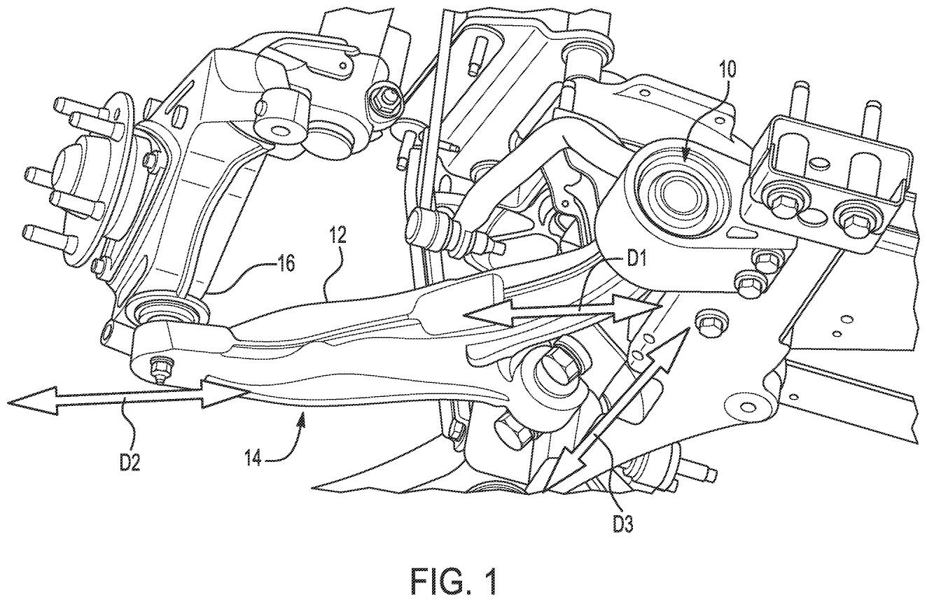

FIG. 1 depicts an automotive and suspension application of the vehicle joint and bushing assembly 10; still, other applications and components are possible in other embodiments. A suspension control arm 12 of a suspension assembly 14 can be moved in a direction D1 via adjustments made at the vehicle joint and bushing assembly 10, which serves to move a steering knuckle 16 in a direction D2 for proper vehicle alignment purposes; still, other directions of adjustment and directions of alignment are possible via the vehicle joint and bushing assembly 10. Previous approaches that involved a cam bolt have been shown to permit movements solely in an unwanted direction D3, absent the addition/removal of costly shim plates.

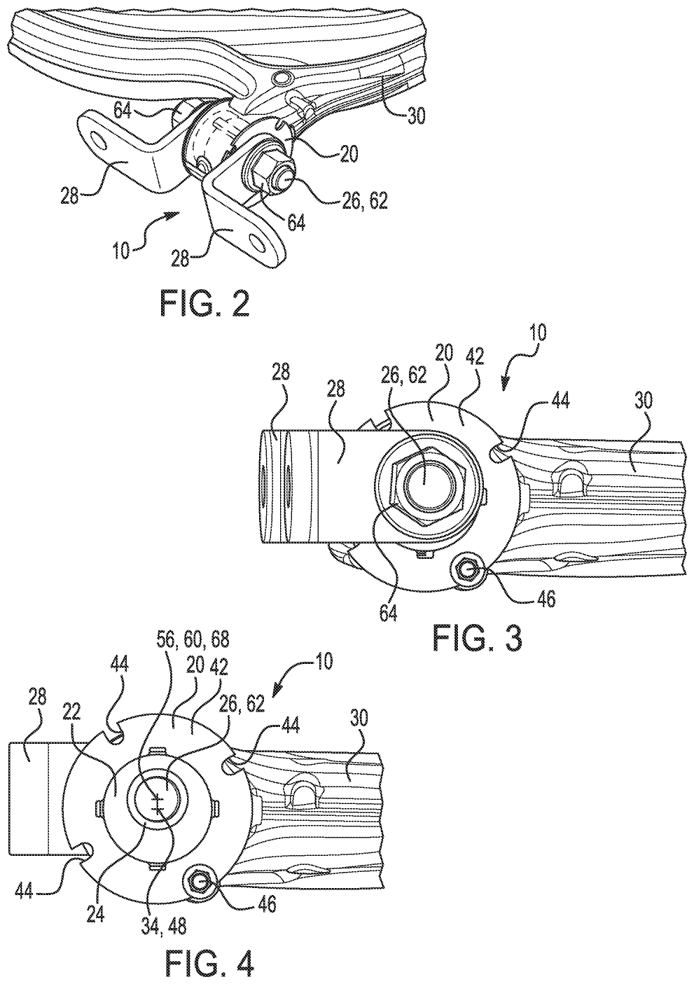

The vehicle joint and bushing assembly 10 can have various designs, constructions, and components in various embodiments depending on, among other potential factors, the particular application, intended adjustments to be made and desired alignments, and the particular components involved. In the embodiment of FIGS. 2-8, the vehicle joint and bushing assembly 10 has a joint opening 18, a first sleeve 20, a second sleeve 22, a third sleeve 24, a retention member 26, and supports 28, among other components that are described below; still, other embodiments could have more, less, and/or different components than those set forth herein.

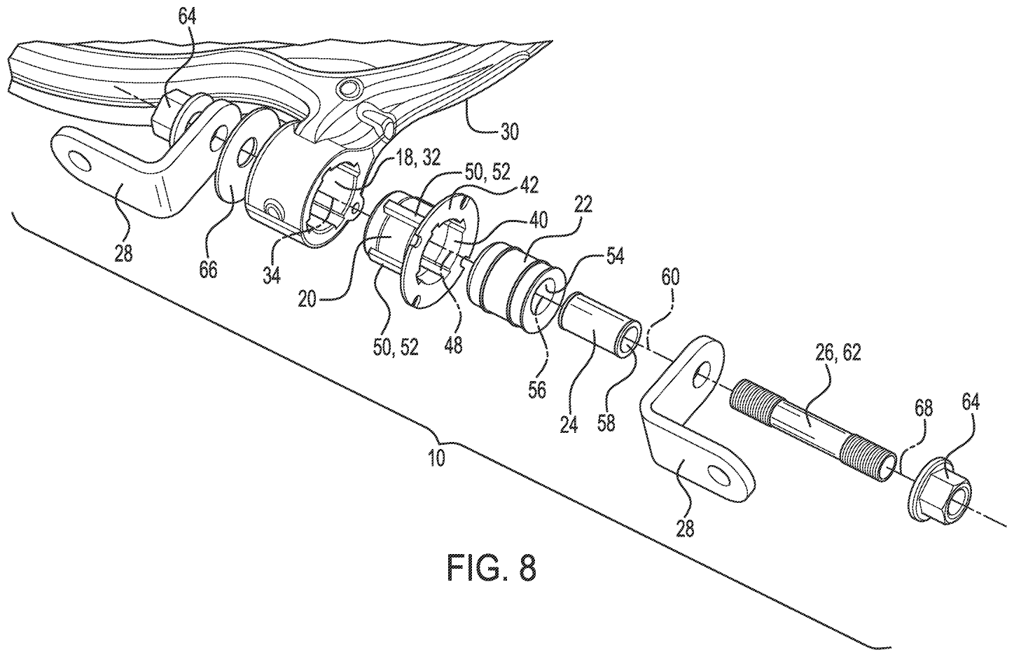

The joint opening 18 resides in a suspension control arm 30 according to this embodiment and receives insertion of the first, second, and third sleeves 20, 22, 24, as well as the retention member 26. With reference to FIGS. 6, 7, and 8, the joint opening 18 in this embodiment is a through-passage that spans wholly through the suspension control arm 30 and that has open ends at its opposite sides, as shown. The joint opening 18 is generally cylindrical in shape, and establishes an interior within its cylindrical internal wall 32. A first centerline 34 (FIG. 8) spans through a center of the joint opening 18 and of the through-passage. The first centerline 34 constitutes a central axis of the joint opening 18. In order to facilitate and guide placement of the first sleeve 20 upon its insertion and reception in the joint opening 18, indexing constructions are provided between the first sleeve 20 and the joint opening 18. The indexing constructions serve to locate the first sleeve 20 in intended rotational positions with respect to the joint opening 18. In coordination with an offset arrangement (described below), rotational adjustments and movements of the first sleeve 20 relative to the joint opening 18 among indexed positions can furnish preestablished vehicle alignment alterations and tuning-in this regard, the precise quantity of the indexing constructions, and angular and circumferential locations relative to one another, can vary based upon the particular application, intended adjustments to be made and desired alignments, as well as the particular components involved.

The indexing constructions can have various designs, constructions, and components in various embodiments. In the embodiment of the figures, and as perhaps shown best by FIG. 6, the joint opening 18 has a plurality of first indexing constructions 36. The plurality of first indexing constructions 36 mate with a plurality of second indexing constructions (introduced below) of the first sleeve 20, and hence the indexing constructions are complementary in terms of their design and construction and quantity. In this example, there are a total of four individual first indexing constructions 36 set approximately ninety degrees (90°) apart from one another around the circumference of the joint opening 18 and around its cylindrical shape; still, in other embodiments, other quantities and locations are possible (e.g., six set sixty degrees (60°) apart, eight set forty-five degrees (45°) apart, twelve set thirty degrees (30°) apart). In the embodiment here, the plurality of first indexing constructions 36 is in the form of depressions 38. The depressions 38 are formations in the internal wall 32 of the joint opening 18. Each depression 38 is somewhat rectangular in shape, and has an elongated axial extent spanning from an open end at the respective open end of the joint opening 18 to a closed end situated within the joint opening's interior (“axial” used here with reference to the cylindrical joint opening 18).

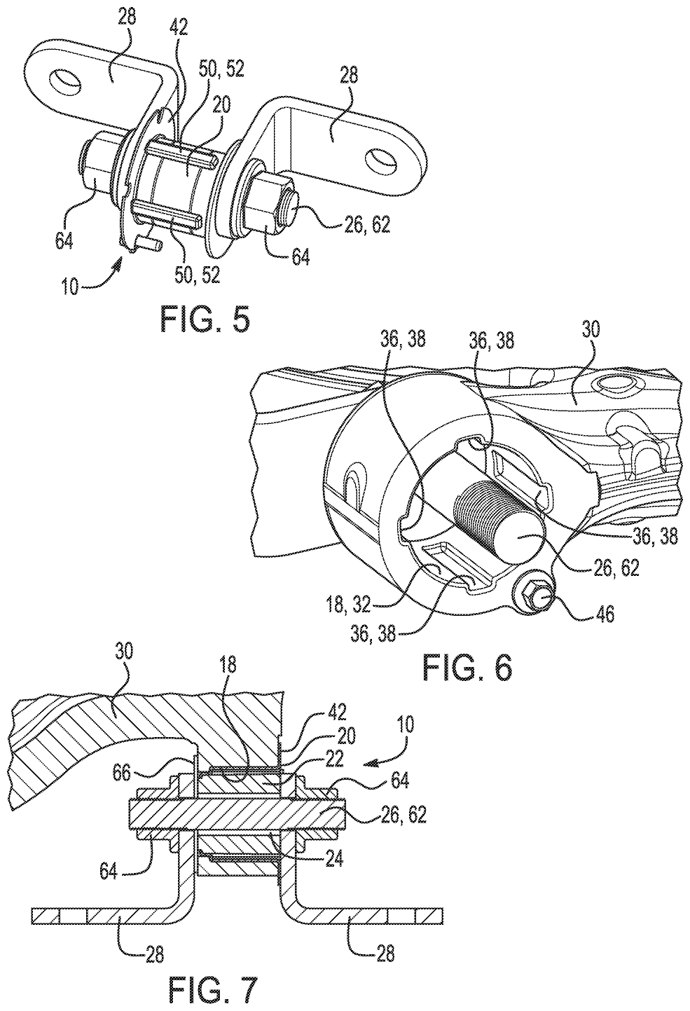

The first sleeve 20 is insertable and receivable in the joint opening 18 upon assembly and installation of the vehicle joint and bushing assembly 10. The first sleeve 20 receives insertion of the second sleeve 22. The first sleeve 20 has a generally cylindrical shape, and can be composed of a metal material. With reference now to FIGS. 5 and 8, the first sleeve 20 establishes a first passage 40 that spans wholly therethrough with open ends on opposite sides. Adjacent one open end, a flange 42 is provided for facilitating seating of the first sleeve 20 within the joint opening 18. Notches 44 (FIGS. 3 and 4) are defined in the flange 42 for accommodating a screw 46 that, when in place, rotationally constrains the first sleeve 20 with respect to the joint opening 18, once insertion and reception occurs therebetween. A second centerline 48 (FIG. 8) spans through a center of the first sleeve 20 and of the first passage 40. The second centerline 48 constitutes a central axis of the first sleeve 20. The second centerline 48 exhibits a coincident and concentric arrangement with respect to the first centerline 34 of the joint opening 18.

For mating with the plurality of first indexing constructions 36 of the joint opening 18, the first sleeve 20 has a plurality of second indexing constructions 50. In this example, there are a total of four individual second indexing constructions 50 set approximately ninety degrees (90°) apart from one another around the circumference of the first sleeve 20 and around its cylindrical shape; still, in other embodiments, other quantities and locations are possible (e.g., six set sixty degrees (60°) apart, eight set forty-five degrees (45°) apart, twelve set thirty degrees (30°) apart). The number of first and second indexing constructions 36, 50 can correspond to each other. In the embodiment here, the plurality of second indexing constructions 50 is in the form of projections 52. The projections 52 slide into the depressions 38. The projections 52 are external formations at a wall of the first sleeve 20. Like each depression 38, each projection 52 is somewhat rectangular in shape and has an elongated axial extent (“axial” used here with reference to the cylindrical first sleeve 20). Mating of the projections 52 and depressions 38 works to rotationally constrain the first sleeve 20 with respect to the joint opening 18.

The second sleeve 22 is locatable within the first sleeve 20, and is insertable and receivable in the first passage 40 of the first sleeve 20. With reference to FIG. 8, the second sleeve 22 has a generally cylindrical shape, and can be composed of a metal material, a rubber material, or a combination thereof. In assembly and installation and use, the second sleeve 22 has a rotational degree of freedom (DoF) with respect to the first sleeve 20; i.e., the second sleeve 22 can rotate relative to the first sleeve 20 during use of the vehicle joint and bushing assembly 10. The second sleeve 22 establishes a second passage 54 that spans wholly therethrough with open ends on opposite sides. A third centerline and axis 56 spans through a center of the second sleeve 22 and of the second passage 54. The third centerline 56 constitutes a central axis of the second sleeve 22. The third centerline 56 exhibits an offset and eccentric arrangement with respect to the first centerline 34 of the joint opening 18 and with respect to the second centerline 48 of the first sleeve 20. The offset and eccentric arrangement is illustrated in FIG. 4. The precise offset can be predetermined based on, among other potential factors, the anticipated vehicle alignments that may be called for in a particular application, and hence may vary. Furthermore, in a similar manner, the second passage 54 exhibits an offset and eccentric arrangement with respect to the through-passage of the joint opening 18 and with respect to the first passage 40 of the first sleeve 20.

The third sleeve 24 is locatable within the second sleeve 22, and is insertable and receivable in the second passage 54 of the second sleeve 22. The third sleeve 24 receives insertion of the retention member 26. With reference again to FIG. 8, the third sleeve 24 has a generally cylindrical shape, and can be composed of a compressible material such as a rubber material. The third sleeve 24 establishes a third passage 58 that spans wholly therethrough with open ends on opposite sides. A fourth centerline and axis 60 spans through a center of the third sleeve 24 and of the third passage 58. The fourth centerline 60 constitutes a central axis of the third sleeve 24. The fourth centerline 60 exhibits a coincident and concentric arrangement with respect to the third centerline 56 of the second sleeve 22, and exhibits an offset and eccentric arrangement with respect to the first centerline 34 of the joint opening 18 and with respect to the second centerline 48 of the first sleeve 20—these arrangements are illustrated in FIG. 4. Furthermore, in a similar manner, the third passage 58 exhibits a coincident and concentric arrangement with respect to the second passage 54 of the second sleeve 22, and exhibits an offset and eccentric arrangement with respect to the through-passage of the joint opening 18 and with respect to the first passage 40 of the first sleeve 20.

The retention member 26 and the supports 28 serve to connect the suspension control arm 30 to another vehicle component, such as to a chassis component of the larger automobile according to this embodiment. The retention member 26 is inserted into the third sleeve 24 and supported thereby. With reference now to FIGS. 4, 7, and 8, in this embodiment the retention member 26 is in the form of a bolt 62 with threaded ends that are fastened by nuts 64 in assembly and installation of the vehicle joint and bushing assembly 10. A washer or spacer 66 can also be provided in the vehicle joint and bushing assembly 10. The bolt 62 extends axially fully through the varying passages of the joint opening 18, first sleeve 20, second sleeve 22, and third sleeve 24, and constitutes the radially-innermost component of the vehicle joint and bushing assembly 10. Furthermore, a retention centerline 68 spans through a center of the retention member 26. The retention centerline 68 constitutes a central axis of the retention member 26. The retention centerline 68 exhibits a coincident and concentric arrangement with respect to the fourth centerline 60 of the third sleeve 24 and with respect to the third centerline 56 of the second sleeve 22. Further, the retention centerline 68 exhibits an offset and eccentric arrangement with respect to the first centerline 34 of the joint opening 18 and with respect to the second centerline 48 of the first sleeve 20. The supports 28 are in the form of metal brackets according to this embodiment.

In use, and per the embodiment of the vehicle joint and bushing assembly 10 of FIGS. 1-8, the rotational adjustments and vehicle alignment alterations are carried out via the plurality of first and second indexing constructions 36, 50 and via the offset and eccentric arrangements of the passages and centerlines, as described. These designs and constructions are situated internal and within the vehicle joint and bushing assembly 10, and hence more readily accommodate and satisfy external packaging requirements in certain applications. Moreover, the rotational adjustments and vehicle alignment alterations are furnished in a multitude of directions and angles relative to the retention member 26 and its retention centerline 68.

To initiate a rotational adjustment and alter vehicle alignment, the retention member 26 is loosened, and the first, second, and third sleeves 20, 22, 24 are removed from the joint opening 18. From a first rotational position of the first sleeve 20 relative to the joint opening 18, the first and second and third sleeves 20, 22, 24 are rotated to a second rotational position of the first sleeve 20 relative to the joint opening 18. The first and second and third sleeves 20, 22, 24 are then inserted back into the joint opening 18. Still, additional rotational positions are possible, depending on the embodiment. The second rotational position can be in a clockwise or counterclockwise direction with respect to the first rotational position, and can be 30°, 45°, 60°, 90°, 180°, or another angular value from the first rotational position, per various embodiments, depending on the design and construction and quantity of the plurality of first and second indexing constructions 36, 50. Concurrently with the change and adjustment in rotational position, the retention member 26 and retention centerline 68 moves to preestablished off-center positions with respect to the first and second centerlines 34, 48 via the offset and eccentric arrangement. The retention member 26 moves about the first and second centerlines 34, 48 of the joint opening 18 and first sleeve 20. Again here, there can be a multitude of off-center positions depending on the design and construction and quantity of the plurality of first and second indexing constructions 36, 50. Furthermore, in the first and second rotational positions, as well as other rotational positions, the plurality of first and second indexing constructions 36, 50 mate with each other.

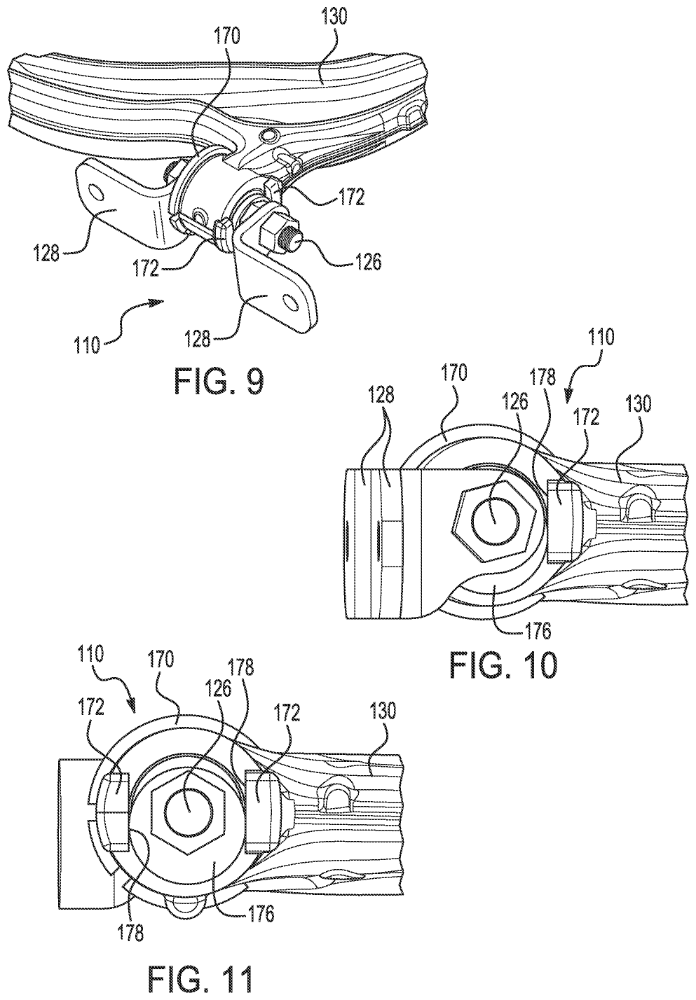

A second embodiment of the vehicle joint and bushing assembly is presented by FIGS. 9-17. In the second embodiment, corresponding components are numbered similarly but with the numerals 1xx as an indication of this second embodiment. For example, the vehicle joint and bushing assembly is indicated by numeral 10 in the previous embodiment, and is correspondingly indicated by numeral 110 in the second embodiment. Moreover, similarities may exist between the previous embodiment and the second embodiment, some of which may not be repeated here in the description of the second embodiment.

As before, the vehicle joint and bushing assembly 110 has a joint opening 118, a first sleeve 120, a second sleeve 122, a third sleeve 124, a retention member 126, and supports 128. The vehicle joint and bushing assembly 110 further includes a spacer 170 in the second embodiment. Still, other embodiments could have more, less, and/or different components than those set forth herein.

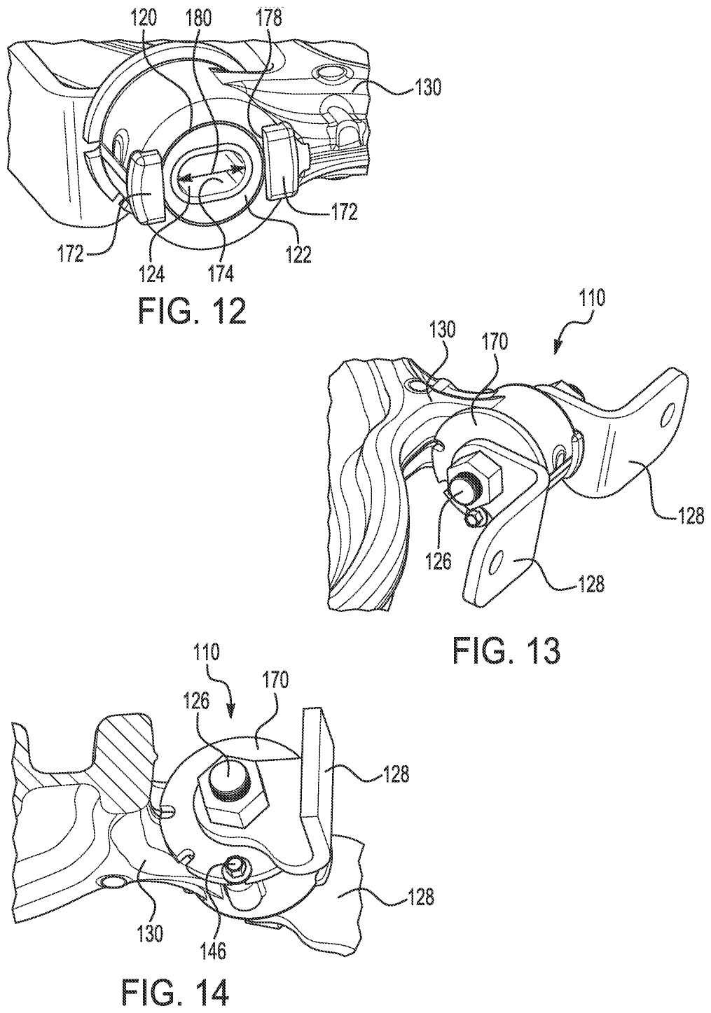

Main differences with this second embodiment compared to the previous embodiment include reacting structures 172 of a suspension control arm 130, a slotted passage 174 of the third sleeve 124, and a cam 176 of the retention member 126. In general, the reacting structures 172 and cam 176 work together during use to prompt movement of the retention member 126 along the slotted passage 174 for adjustments and vehicle alignment alterations. With reference to FIGS. 11 and 12, the reacting structures 172 reside adjacent the joint opening 118 and on opposite sides thereof. The reacting structures 172 extend from one of the open ends of the joint opening 118 at an exterior thereof. In this embodiment, the reacting structures 172 are in the form of a pair of lances that are cast-in-place in the suspension control arm 130. Reacting surfaces 178 of the reacting structures 172 make surface-to-surface urging engagement with a side surface of the cam 176.

The slotted passage 174 accommodates translational side-to-side movements of the retention member 126 and its centerline therealong amid adjustments in the vehicle joint and bushing assembly 110. With reference to FIGS. 12, 16, and 17, the second sleeve 122 has a slotted passage for accommodating reception of the third sleeve 124 therein, per this embodiment. The third sleeve 124 can be composed of a metal material, according to this embodiment, and the second sleeve 122 can be composed of a compressible material such as a rubber material. The slotted passage 174 has an elongate radial extent 180 (FIG. 12) (“radial” used here with reference to the cylindrical first sleeve 120). The retention member 126 is able to move to a multitude of radial positions along the elongate radial extent 180 and side-to-side between terminal ends thereof. For example, the somewhat central location of the retention member 126 depicted in FIG. 16 can constitute a first radial position, and movement of the retention member 126 therefrom and toward either of the terminal ends of the slotted passage 174 can constitute a second radial position. Many radial positions are possible. Moreover, in addition to translational movements of the retention member 126, the slotted passage 174 can be rotationally oriented with respect to the joint opening 118 upon assembly and installation of the vehicle joint and bushing assembly 110 according to, among other potential factors, the anticipated vehicle alignments that may be called for in a particular application and the desired direction of translational movements of the retention member 126.

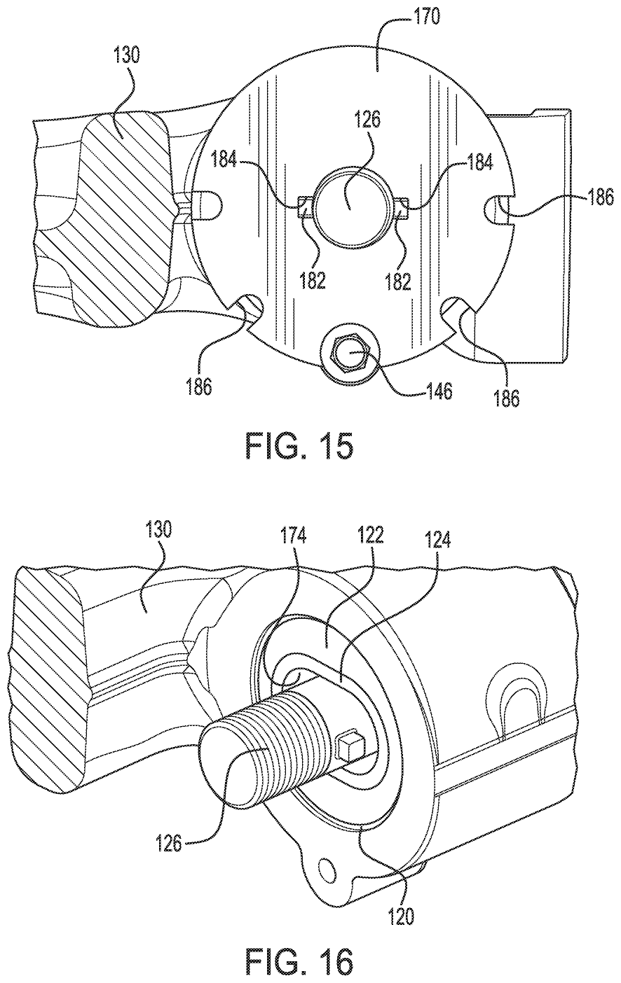

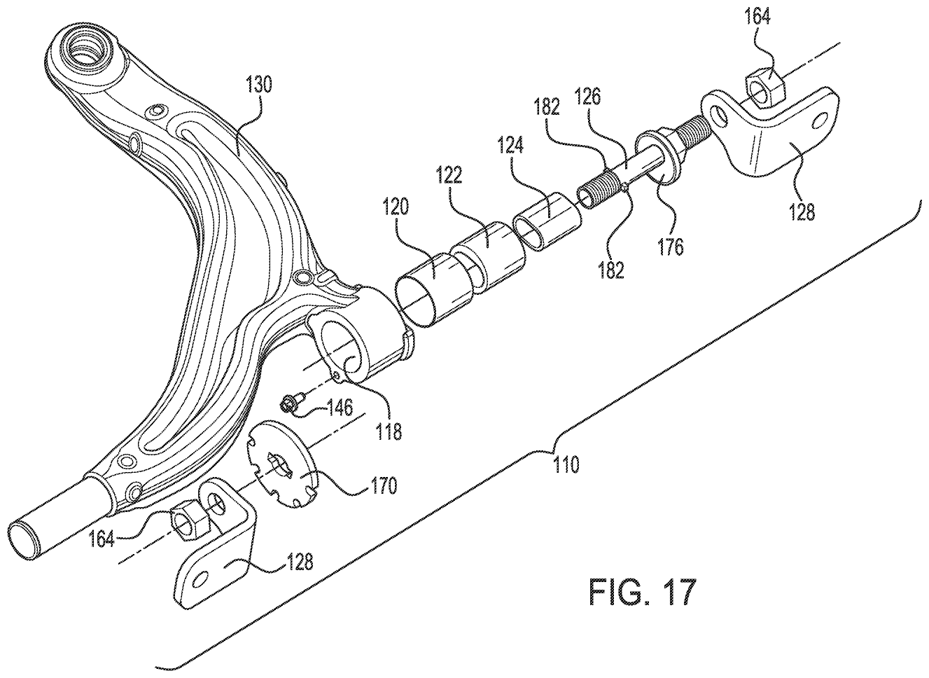

The cam 176 serves to urge the retention member 126 along the elongate radial extent 180 of the slotted passage 174 upon rotation of the retention member 126 and upon engagement of the cam 176 with the reacting structures 172. In the second embodiment, the retention member 126 is rotated from the first rotational position to the second rotational position—as well as possibly to and from other rotational positions—in order to initiate a translational adjustment of the retention centerline of the retention member 126 for vehicle alignment alterations. With reference now to FIGS. 11 and 17, the cam 176 extends radially-outwardly of a main shank of the retention member 126. In this embodiment too, the retention member 126 is in the form of a bolt with threaded ends that are fastened by nuts 164. When assembled and installed, the cam 176 remains outside of the slotted passage 174 and at the reacting structures 172 for engagement therewith. Furthermore, a pair of tabs 182 extends radially-outwardly from the main shank of the retention member 126 and are received in openings 184 of the spacer 170 in assembly (such reception is illustrated in FIG. 15). This reception serves to rotationally constrain the retention member 126 to the spacer 170. Notches 186 defined in the spacer 170 are for accommodating a screw 146 that, when in place, rotationally constrains the spacer 170 and hence the retention member 126 with respect to the joint opening 118.

As used herein, the terms “general,” “generally,” “approximately,” and “substantially” are intended to account for the inherent degree of variance and imprecision that is often attributed to, and often accompanies, any design and manufacturing process, including engineering tolerances—and without deviation from the relevant functionality and outcome—such that mathematical precision and exactitude is not implied and, in some instances, is not possible. In other instances, the terms “general,” “generally,” “approximately,” and “substantially” are intended to represent the inherent degree of uncertainty that is often attributed to any quantitative comparison, value, and measurement calculation, or other representation.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A vehicle joint and bushing assembly, comprising:
a joint opening having a first centerline;
a first sleeve receivable in said joint opening, said first sleeve having a second centerline; and
a second sleeve locatable within said first sleeve;
wherein, upon rotation at the vehicle joint and bushing assembly between a first rotational position and a second rotational position, a retention centerline of a retention member locatable within said second sleeve is moveable with respect to said first centerline of said joint opening and with respect to said second centerline of said first sleeve.

2. The vehicle joint and bushing assembly as set forth in claim 1, wherein the first and second rotational positions are of said first and second sleeves with respect to said joint opening, said joint opening having a plurality of first indexing constructions and said first sleeve having a plurality of second indexing constructions, said plurality of first and second indexing constructions mating with one another when said first and second sleeves are in the first and second rotational positions.

3. The vehicle joint and bushing assembly as set forth in claim 1, wherein said second sleeve has a passage establishing an axis, said axis possessing an offset arrangement with respect to said first centerline of said joint opening and with respect to said second centerline of said first sleeve when in the first and second rotational positions, the retention centerline of the retention member possessing a coincident arrangement with respect to said axis.

4. The vehicle joint and bushing assembly as set forth in claim 1, wherein said joint opening has a plurality of first indexing constructions and said first sleeve has a plurality of second indexing constructions, said plurality of first and second indexing constructions being complementary to each other; and
wherein rotation between the first and second rotational positions is rotation of said first and second sleeves with respect to said joint opening, in the first rotational position said plurality of first and second indexing constructions mate with one another and the retention centerline of the retention member possesses a first eccentric arrangement with respect to said first and second centerlines, and in the second rotational position said plurality of first and second indexing constructions mate with one another and the retention centerline of the retention member possesses a second eccentric arrangement with respect to said first and second centerlines.

5. The vehicle joint and bushing assembly as set forth in claim 1, further comprising a third sleeve locatable within said second sleeve, said third sleeve receiving insertion of the retention member, and wherein, upon insertion of the retention member in said third sleeve, the retention centerline of the retention member possesses a first eccentric arrangement with respect to said first and second centerlines in the first rotational position, and the retention centerline of the retention member possesses a second eccentric arrangement with respect to said first and second centerlines in the second rotational position.

6. The vehicle joint and bushing assembly as set forth in claim 5, wherein said second sleeve has a passage that receives insertion of said third sleeve, said passage possessing an offset arrangement with respect to said first and second centerlines.

7. The vehicle joint and bushing assembly as set forth in claim 1, wherein a slotted passage resides at said second sleeve, said slotted passage having an elongate radial extent and receiving insertion of the retention member; and
wherein rotation between the first and second rotational positions is rotation of the retention member with respect to said slotted passage, in the first rotational position the retention member is located at a first radial position along the elongate radial extent of said slotted passage, and in the second rotational position the retention member is located at a second radial position along the elongate radial extent of said slotted passage.

8. The vehicle joint and bushing assembly as set forth in claim 7, wherein, upon rotation of the retention member between the first and second rotational positions, a cam of the retention member is urged against a reacting structure adjacent said joint opening, the urging of the cam against the reacting structure prompts movement of the retention member over the elongate radial extent of said slotted passage.

9. The vehicle joint and bushing assembly as set forth in claim 1, wherein said second sleeve has a slotted passage with an elongate radial extent, the retention member locatable within said slotted passage, and wherein rotation between the first and second rotational positions is rotation of the retention member with respect to said slotted passage, and upon rotation of the retention member a cam of the retention member prompts movement of the retention member over the elongate radial extent of said slotted passage.

10. The vehicle joint and bushing assembly as set forth in claim 1, further comprising a third sleeve locatable within said second sleeve, said third sleeve receiving insertion of the retention member at a slotted passage thereof, said slotted passage having an elongate radial extent, and wherein in the first rotational position the retention member is located at a first radial position along the elongate radial extent of said slotted passage, and in the second rotational position the retention member is located at a second radial position along the elongate radial extent of said slotted passage.

11. A vehicle joint and bushing assembly, comprising:
a joint opening having a centerline;
at least one sleeve locatable in said joint opening; and
a retention member supported via said at least one sleeve, said retention member moveable to off-center positions with respect to said centerline of said joint opening upon rotation at the vehicle joint and bushing assembly.

12. The vehicle joint and bushing assembly as set forth in claim 11, wherein said at least one sleeve includes a first sleeve and a second sleeve locatable within said first sleeve, said second sleeve establishing a passage, said retention member moveable via said passage to off-center positions with respect to said centerline of said joint opening upon rotation at the vehicle joint and bushing assembly.

13. The vehicle joint and bushing assembly as set forth in claim 11, wherein rotation at the vehicle joint and bushing assembly is rotation of said at least one sleeve with respect to said joint opening, said joint opening has a plurality of first indexing constructions and said at least one sleeve has a plurality of second indexing constructions, the retention member is supported via a passage of said at least one sleeve, said passage possessing an eccentric arrangement with respect to said centerline of said joint opening, said plurality of first and second indexing constructions mate with one another upon rotation of said at least one sleeve with respect to said joint opening and upon said retention member moveable to the off-center positions via said passage with respect to said centerline of said joint opening.

14. The vehicle joint and bushing assembly as set forth in claim 11, wherein said at least one sleeve has a slotted passage with an elongate radial extent, the retention member is supported via said slotted passage, rotation at the vehicle joint and bushing assembly is rotation of the retention member with respect to said slotted passage, and upon rotation of the retention member a cam of the retention member prompts movement of the retention member to the off-center positions over the elongate radial extent of said slotted passage.
